(19) United States
(12) Patent Application Publication
(10) Pub. No.: US 2014/0004481 A1
(43) Pub. Date: Jan. 2, 2014

(54) Crestal Implant And Method For Processing Same

(71) Applicant: Frank-Peter Spahn, Hasselt (BE)

(72) Inventor: Frank-Peter Spahn, Hasselt (BE)

(21) Appl. No.: 13/922,984

(22) Filed: Jun. 20, 2013

Related U.S. Application Data
(63) Continuation of application No. PCT/EP2011/073336, filed on Dec. 20, 2011.

(30) Foreign Application Priority Data
Dec. 20, 2010 (DE) 20 2010 013 168.5
Mar. 18, 2011 (DE) 10 2011 001 401.2

(51) Int. Cl. A61C 8/00

(52) U.S. Cl. CPC A61C 8/0037; A61C 8/0013
USPC 433/173; 433/201.1

(57) ABSTRACT

A crestal implant including an elongate anchoring section, an implant stump and a transition section. The anchoring section has an elongate core from which several ribs extend forming rib groups. One or more surfaces which extend in the circumferential direction at a radial reference distance from the longitudinal central axis are provided on the transition section. One or more rib groups, in which the radially outer rib edge of the ribs has a radial distance from the longitudinal central axis of the implant, at least approximately corresponding to the radial reference distance, and one or more rib groups are provided within which only some ribs thereof, or within which all the ribs thereof, have on the radially outer rib edges along the entire or partial circumferential extension, a radial distance from the longitudinal central axis which is greater than the radial reference distance.

### FIELD OF THE INVENTION

The present invention relates in first instance to a crestal implant, comprising an elongate anchoring portion extending in a longitudinal direction, an implant stump, and a transition portion between the anchoring portion and the implant stump, the anchoring portion having an elongate core from which a plurality of ribs extend that are distributed in the longitudinal direction and in the peripheral direction, the ribs forming rib groups, each of which comprises a plurality of ribs that are arranged distributed on the core periphery at a common core cross-section, one or more surfaces being provided at the transition portion, which surface or surfaces extend in the peripheral direction at least in certain peripheral portions at a radial reference distance from the geometrical longitudinal center axis, and the implant containing plastics and preferably consisting of plastics.

### BACKGROUND OF THE INVENTION

The implants at issue within the context of the invention are used as an artificial tooth root which can be anchored by a dentist or surgeon in the bone of the upper or lower jaw, and on the implant stump of which a dental prosthesis such as, e.g., a dental crown can be anchored. Such implants are therefore also referred to as dental implants or occasionally also as jaw implants, depending on their implantation site. In the literature, the implant stump is also referred to as an abutment. In this connection, different implant types are known in the prior art. Metallic crestal implants, the actual traditional implants in a tooth root-like shape, have on their anchoring portion a thread (or two threads with different thread pitches so as to achieve a kind of compression) by means of which they can be screwed into the bone. Force transmission in such implants takes place in the crestal direction or in the so-called collar region which adjoins the thread region. Since the jaw bone bends when opening the mouth or when biting, and the collar region thus changes, the healing time for traditional implants is problematic. However, the bone material may also disengage from the implant at a later time, since the metal traditionally used for implants is not able to adapt to the internal movements of the jaw bone. Up to now it was attempted in the industry to eliminate this problem with different surface treatments and compressive surface configurations. In addition, there is the difficulty that implants are needed for different anatomical conditions. Thus, there is a large number of suppliers on the market, each of which offers a variety of different implants (often at least five types, but also up to thirty or forty different types) in different sizes and with different surfaces and also different prosthetic abutment parts. In this respect, the prosthetic abutment parts are likewise important distinguishing features for the suppliers, since the problem of mucosal penetration of the implant and attaching the dental crown to be placed thereon can be addressed differently and has to be resolved individually. Conventionally, for each implant system a rather large number of auxiliary parts (e.g., ca. forty auxiliary parts) is thus needed which should enable the dentist to find the aesthetically and functionally best solution. This is necessary since for conventional crestal screw implants, metal, preferably titanium, is used, which must not be machined and changed by the dentist, since otherwise the crystalline structure of the material could be damaged and corrosion could occur.

### SUMMARY OF THE INVENTION

Against this background, it is an object of the invention to advantageously improve a implant of the generic kind so that in particular individual or a plurality of the aforementioned limitations can be avoided as far as possible.

The object is achieved according to the invention in first instance and substantially in connection with the features that one or more rib groups are provided in which, for all ribs, the radially outer rib edge, along the entire or only partial peripheral extent thereof, has a radial distance from the geometrical longitudinal center axis of the implant that corresponds or approximately corresponds to the radial reference distance, and that one or more further rib groups are provided within which not all ribs thereof but only some of the ribs, preferably only two ribs situated opposite from one another on the core periphery, or all ribs of the ribs of said further rib groups, have at their radially outer rib edge, along the entire or only partial peripheral extent thereof, a radial distance from the geometrical longitudinal axis that is greater than the radial reference distance. Such an implant advantageously enables, especially with regard to the particular arrangement and formation of the ribs and with regard to the plastics-based production thereof, that the implant, based on only one individual basic construction and size, can be adapted by the attending physician to different anatomical conditions, even immediately prior to use. To this end, there is in particular the possibility of shortening the implant as needed in the longitudinal direction at individual or a plurality of places, and/or working on, in particular shortening, the ribs of the implant so as to be able to adapt the anchoring portion, in the radial direction or in terms of its width, to jawbone bores with different diameters. Instead of a larger number of conventional implants, wherein a number of approximately five to forty can be regarded as typical, only one implant according to the invention is needed, which can be cut to size or ablated in the basal and/or crestal region, shortening in the longitudinal direction in the region of the anchoring portion only requiring cutting through the core with its comparatively small cross-section between the rib groups, which are spaced apart from one another in the longitudinal direction and extend from the core. The width, i.e., the implant cross-section which is determined by the outer rib edges and is effective for anchoring, in particular the diameter of an imaginary circular curve which is concentric with the geometrical longitudinal center axis and by which the rib edges of a rib group are delimited, can be changed in that preferably each of those ribs which have a radial distance between the radially outermost rib edge and the geometrical longitudinal center axis that is greater than the reference distance are ablated as needed on their free longitudinal ends or edges. Possible configurations that are preferred in this respect will be discussed later. As also described hereinafter, the implant according to the invention can preferably be formed and improved in such a manner that the result is a dowel-like shape and functionality. With regard to the fact that the implant contains plastics or consists of plastics, the possibility advantageously arises to select the implant material such that this material has virtually the same modulus of elasticity as the jawbone. Preferably, the implant can be produced from polyether ether ketone (PEEK) or a mixture of different polyether ether ketones, whereby virtually the same modulus of elasticity as that of the jawbone can be achieved. Thus, the problems of conventional metal implants in the crestal collar region do not exist here, since during bending, the bone does not move away from the implant, but, rather, bends together with the implant and in the same manner as the implant. Also, since the implant is produced from plastics-based material or from plastics, the connection to the prosthesis does not present any problems, since after insertion, the crestal end protruding from the mucosa can be ground like a tooth with a rotating instrument according to the needs. Metallurgical problems, such as corrosion, are excluded since no metal is incorporated. An implant, on the one hand, should transmit force, and on the other hand should not be able to disengage from the bone. In the case of conventional metallic implant bodies, this is achieved via threads which these implants carry and which are pretapped in the bone, which is not homogenous, and which then should approximately match. In contrast, in the case of the implant according to the invention, which in a preferred embodiment can also be referred to as a so-called P-CIS implant, the force can be transmitted by the ribs, which are formed without a pitch angle, and can preferably be transmitted via the conical collar region. Since in contrast to metal, the material polyether ether ketone (PEEK) deforms when it meets hard edges, it is possible to prepare for the implant insertion into the jawbone by making the bores in the jaw slightly narrower than is required by the surface of the implant for the insertion process. The implant can be driven into such a bore, the ribs engaging in a somewhat elastic manner. At the final location, the springs unfold again elastically without damaging bone cells by excessive pressure, since the same or virtually the same modulus of elasticity is present, and the bone thus determines the unfolding speed of the ribs. The ribs then prevent disengagement from the bore channel so that no thread is required. Thus, the anchoring portion with the ribs can be used for anchoring the implant in the jawbone and, together with the transition portion and, depending on the anatomical conditions, optionally also with a portion of the implant stump, can transmit the loads that occur, for which purpose a certain portion of the implant stump can also be inserted into the jawbone. Conventionally, the transition portion and, if applicable, depending on the embodiment, the implant stump (or a part thereof) are referred to as the collar region.

It is preferably provided that a core cross-section, on the core periphery of which the ribs of a rib group are disposed, is in each case a cross-section that is planar in itself and is perpendicular to the geometrical longitudinal center axis, and/or that the rib edges of a rib group also extend in the peripheral direction in a common cross-section that is perpendicular to the longitudinal center axis. It is preferred that the ribs have no pitch and in this respect do not form a thread. With regard to the above-described dowel-like functionality, which instead is present here, in which the ribs in the bore channel initially engage against the core and then unfold again and wedge the implant within the bore channel in this manner, it is also regarded as an advantage that the desired anchoring can also be achieved in different rotational positions of the implant about the geometrical longitudinal center axis thereof.

A preferred refinement is seen in the fact that each of the rib groups have a plurality of ribs, preferably four ribs in each case, of which ribs, for each rib group, only two ribs situated opposite from one another on the core periphery have at their radially outer rib edge, along the entire or only partial (i.e., if applicable only locally) peripheral extent thereof, a radial distance from the geometrical longitudinal axis that is greater than the radial reference distance, and of which ribs, the remaining ribs have at their radially outer rib edge, along the entire or only partial (i.e., if applicable only locally) peripheral extent thereof, a radial distance from the geometrical longitudinal center axis that corresponds or approximately corresponds to the reference distance. With regard to the transition portion, it is preferred that this transition portion has a core from which a plurality of peripheral segments extend radially outwardly, which segments are arranged distributed in the peripheral direction and spaced apart from one another, and the radially outer surfaces of which extend at the radial reference distance from the geometrical longitudinal center axis in the peripheral direction and in the longitudinal direction along an imaginary cylindrical enveloping surface. With regard to the anchoring portion, it is preferred that the radially outermost rib edge of only some or of all ribs that belong to the same rib group extends along an imaginary circular line that is concentric with the geometrical longitudinal center line. Along a peripheral direction extending around the longitudinal center axis, the outermost rib edge then has a constant radial distance therefrom. It is regarded as advantageous that a plurality of rib groups, within which only for individual (i.e., not all) ribs or for all ribs, a radial distance between the radially outermost rib edge and the geometrical longitudinal center axis is greater than the radial reference distance, are disposed successively in the longitudinal direction, i.e., without rib groups which are disposed therebetween in the longitudinal direction and for which, for all ribs in each case, the radial distance between the radially outermost rib edge and the geometrical longitudinal center axis of the implant corresponds or approximately corresponds to the radial reference distance.

There is the possibility that rib groups, in which only for individual (i.e., not all) ribs or for all ribs a radial distance between the radially outermost rib edge and the geometrical longitudinal center axis is greater than the radial reference distance, differ from one another from rib group to rib group in terms of this radial distance. It is particularly preferred that in a sequence of a plurality of such rib groups, a radial distance which, compared to the radial reference distance, is for the implant a so-called first, maximum radial distance of the outer rib edges from the longitudinal center axis, is associated with at least one so-called first rib group, and that in the longitudinal direction, on one or both sides of this so-called first rib group, one or more so-called second rib groups are disposed, with which a so-called second radial distance—which is greater than the radial reference distance—of the outer rib edges from the longitudinal center axis is associated, which second radial distance is less than the first radial distance and greater than the radial reference distance.

There is the possibility that in a sequence of a plurality of rib groups, in which only for individual (i.e., not all) ribs or for all ribs, a radial distance between the radially outermost rib edge and the geometrical longitudinal center axis is greater than the radial reference distance, between at least one so-called second rib group with which the so-called second radial distance of the outer rib edges from the longitudinal center axis is associated, and at least one rib group with which, for all ribs, the radial reference distance of the outer rib edges from the longitudinal center axis is associated, at least one so-called third rib group is disposed, with which a so-called third radial distance—which is greater than the radial reference distance—of the outer rib edges from the longitudinal center axis is associated, which third radial distance is less than the mentioned second radial distance from the longitudinal center axis and greater than the radial reference distance. It is also preferred that, viewed in the longitudinal direction, on either side of a sequence of a plurality of rib groups, within which only for individual (i.e., not all) ribs or for all ribs, a radial distance between the radially outermost rib edge and the geometrical longitudinal center axis is greater than the radial reference distance, one or more rib groups are disposed, for which, in particular for all ribs in each case, a radial distance between the radially outermost rib edge and the geometrical longitudinal center axis of the implant corresponds or approximately corresponds to the radial reference distance.

With regard to the rib cross-section, it is preferred that ribs whose radial distance between the radially outermost rib edge and the geometrical longitudinal center axis corresponds at least approximately to the radial reference distance have a triangular cross-section in a cross-sectional plane that extends through the geometrical longitudinal center axis. On the other hand, it is preferred that ribs whose radial distance between the radially outermost rib edge and the geometrical longitudinal center axis is greater than the radial reference distance have a cross-section in a cross-sectional plane that extends through the geometrical longitudinal center axis, which cross-section extends from a base adjoining the core cross-section and tapers into an elongate extension, it being preferably provided that the extension has a cross-sectional thickness that is approximately constant, at least in certain length portions. In particular, such ribs, also benefitting from being produced from plastics material, exhibit an elastic deformability which, when the implant is inserted into the bore channel, facilitates a flexibly resilient engagement against the core cross-section and a subsequent elastic unfolding or spreading from the core. For this, the extensions of the ribs can have a flap-like configuration. Moreover, it is preferred that toward its free end, the elongate extension is inclined with regard to the longitudinal center axis and oriented toward the implant stump so that also in this respect, a dowel-like configuration can be referred to.

A preferred embodiment is also seen in the fact that ribs are disposed in a plurality of rib rows, each rib row comprising in each case a plurality of ribs which are distributed on the core in the longitudinal direction thereof and within peripheral angle intervals on the core periphery that are identical to one another. It is preferably provided that two rib rows are provided on the core periphery which are situated diametrically opposite from one another, and within said rib rows, each rib, at the radially outer rib edge in the peripheral direction thereof, is associated only locally or continuously with the so-called radial reference distance from the geometrical longitudinal center axis. It is preferred in this regard that two further rib rows are provided which likewise are situated diametrically opposite from one another on the core periphery, in each of which ribs are contained, with whose radially outer rib edge, in the peripheral direction of the rib edge, there is locally or continuously associated at least one radial distance from the geometrical center axis that is greater than the radial reference distance. Preferably, the latter-mentioned rib rows contain ribs that differ from one another with regard to their respective radial distance, which is greater than the radial reference distance and, in particular, additionally contain ribs whose radial distance from the geometrical longitudinal center axis corresponds to the radial reference distance. Preferably, these quasi-mixed rib groups face one another in a cross-section which extends through the geometrical longitudinal center axis and which perpendicularly intersects another cross-section in which the two other aforementioned rib groups face one another on the core periphery. It is preferably provided that in each case one peripheral segment of the transition portion also extends in each case within one peripheral angle interval which is associated with one of the rib rows. For example, it is possible that there are four rib rows distributed on the periphery, of which in each case two rib rows are situated diametrically opposite from one another on the periphery of the core. With regard to the two side edges of the ribs in each case, there is the possibility that they extend parallel to one another or approximately parallel to one another, so that the ribs, from the core up to their radially outermost rib edge, have substantially the same rib width. It is preferred that the rib width gradually slightly decreases from the core up to the radially outermost rib edge. It is also preferred that the ribs that belong to a respective rib row are aligned with one another from rib to rib with regard to their side edges. This implies that the radially outermost rib edge of ribs that have a comparatively greater radial distance from the geometrical longitudinal center axis extend in the peripheral direction over a comparatively smaller peripheral angle within the peripheral angle interval. For example, rib edges whose radial distance from the geometrical longitudinal center axis corresponds or approximately corresponds to the radial reference distance can extend within a peripheral angle interval, which spans, e.g. a quarter of the periphery (90 degrees), over a peripheral angle of approximately 45°, while the outer rib edges of other rib groups that have a comparatively greater radial distance extend within the same peripheral angle interval over a correspondingly even smaller peripheral angle.

In order to be able to easily insert the implant into the bore channel, there is the possibility that the implant comprises a foot end, the cross-section of which tapers toward the free longitudinal end of the anchoring portion, and which has a core from which a plurality of foot segments extend radially outward, which segments are arranged distributed in the peripheral direction and spaced apart from one another, it being preferably provided that one foot segment each extends in each case in one peripheral angle interval that corresponds to a peripheral angle interval that is associated with one of the rib rows. There is the possibility that between adjacent rib rows, in particular between adjacent peripheral segments and adjacent foot segments, in each case one concavely rounded fillet extends in particular continuously in the longitudinal direction, in which fillet, at least in some of the rib groups, in each case one stiffening projection is embedded between adjacent ribs.

With regard to simple producibility as well as a desired flexible adaptability to anatomical conditions, it is preferred that the implant is produced as one piece. As already mentioned, plastics is the preferred material, in particular a material composed of or based on polyamide or polyether ketone, preferably from polyether ether ketone (PEEK), or from polyoxymethylene (e.g. Delrin) or the like. In particular polyether ether ketone (PEEK) can be adapted with regard to its modulus of elasticity to the modulus of elasticity of the jawbone. In this respect it is preferred that the implant is made entirely or at least predominantly from plastics.

To be able to prevent an undesired rotation of the implant about its geometrical longitudinal center axis after the insertion of the implant into the jaw, there is the possibility that at the transition portion, between surfaces that extend at least in certain peripheral portions in the peripheral direction at the radial reference distance from the geometrical longitudinal center axis, one or more, preferably two, projections are formed which are situated diametrically opposite from one another on the periphery and extend radially outwardly beyond these surfaces or beyond the radial reference distance, in particular up to the maximum so-called third radial distance between rib edges and the longitudinal center axis, it being preferably provided that the projections, in a cross-sectional plane that is perpendicular to the geometrical longitudinal center axis, have a wedge-shaped radially outwardly tapering cross-section, and in a cross-sectional plane that extends through the geometrical longitudinal center axis, the projections have a rectangular cross-section. The projections, which cause an anti-rotation effect, can also be shortened according to the individual needs, or can be removed completely, for which purpose the projections could be cut or, e.g., ablated, e.g., by means of a cutting instrument (e.g., a knife). With regard to the implant stump, it is preferred that the implant stump is rotationally symmetrical and is in particular formed concentrically with respect to the geometrical longitudinal center axis.

A suitable refinement can be that a first surface region of a dental implant region, the implant material of which consists of polyether ether ketone or at least contains polyether ether ketone, and at least one second surface region of a dental implant region, the implant material of which consists of polyether ether ketone or at least contains polyether ether ketone, are in each case prepared by means of mechanical and/or physical and/or chemical action, so that in terms of its characteristics, at least one surface property of the surface resulting from the preparation of the first surface region differs, at least in certain regions (i.e., portions of the surface or completely), from this surface property of the surface resulting from the preparation of the second surface region, and the characteristic of this surface property of the surfaces resulting from the preparation differs, at least in certain regions, from the characteristic of the surface property of the surface region associated in each case with these surfaces prior to or without the preparation, it being possible that the at least one surface property preferably, but not necessarily essentially, is surface retentivity. In this regard, surface retentivity of surfaces is to be understood as the adherence or retention capability between two bodies or substances, thus, in the present case, between surface regions of the dental implant and at least one kind of, e.g., ions, molecules, body cells (e.g. of the bone, gums or the mucosa) or tissues or the like. There is the possibility to prepare the dental implant not completely or uniformly on its surface, which due to the selected plastics material has inert or non-reactive properties in its untreated initial state, but, rather, to prepare it preferably only on certain surface regions and differently from one another, so that at that location in each case at least one surface property, preferably the surface retentivity, differs from the characteristic of this particular surface property prior to or without the respectively performed preparation, so as to thereby adapt the dental implant in a targeted manner to the locally different requirements in its implantation environment. The [regions] outside of the prepared surface regions of the dental implant are preferably untreated, and preferably have surface properties of the implant material or of PEEK. Conceptually, surface retentivity can also be referred to as retention or retention capability. The retentivity of the surface formed from implant material, which consists of polyether ether ketone or at least contains polyether ether ketone, possesses in the initial state or prior to the preparation according to the invention, an initial or original retentivity that depends on the plastics material itself and also forms a comparative measure for the surface retentivity according to the preparation in accordance with the invention. The preparation of the implant surface or the action on the implant surface makes it advantageously possible to differently alter certain surface properties on surface regions, while the already previously selected material and/or strength properties within the dental implant can remain unchanged. It is possible thereby, on the one hand, that the dental implant possesses uniform, e.g., deformation and strength properties in its interior; on the other hand, if desired, an implant according to the invention which has different surface properties on different surface regions can also have strength and deformation properties (such as, e.g., different moduli of elasticity) that differ from one another in different structural regions. It will be understood that it is possible in this way that the selection or limitation of the surface region to be differentiated with regard to the surface properties can also be different from the selection or limitation of the structural regions to be differentiated with regard to the strength and deformation properties. The mentioned polyether ether ketone can consist of molecules with identical chain lengths, or of molecules with different chain lengths. If reference is made to an implant material that contains at least polyether ether ketone, it is preferred that polyether ether ketone forms the predominant ingredient, to which, however, preferably for influencing the deformation and/or strength properties, certain additives of other substances can be added in preferably comparatively smaller quantities such as, e.g., carbon fibers and/or glass fibers and/or, e.g., titanium fibers or other substances, or organic or inorganic additives with or without a fiber structure. As a starting material for the implant, a material commercially available under the name PEEK-OPTIMA® can be used. Regarding the possibilities for influencing the material properties within the dental implant described in WO 2007/122178 A2, the entire disclosure content of this publication is included in full in the disclosure of the present application, including for the purpose of being able to incorporate features therefrom in the claims. For example, as physical working, among other things, working based on electric or energy-related operating principles is possible. A mechanical action can involve, e.g., a change in form and/or structure, in particular the fine structure, of the implant surface, such as, e.g., removing portions of the surface, roughening the surface or generating individual or a plurality of pores, recesses or the like. Such a mechanical preparation can take place by machining, for example. Alternatively or in combination, a thermal preparation, in particular a change in shape, of the surface region is possible. The surface resulting from the preparation can thus have a shape that differs from the surface of the still unprepared surface region. It will be understood that in the case of further preparation possibilities, the shape of the surface can also remain unchanged during the preparation. Roughening, on the other hand, can also be carried out chemically, for example. As further possibilities of, e.g., a physical or chemical preparation, among other things, depositing, applying, coating or embedding substances can be considered. Further possibilities for preferred refinements are specified.

There is in particular the possibility that the surface shape of at least a portion of the prepared surface region on the implant has been altered prior to or during the deposition of the substance and/or the plasma treatment, preferably by means of hot stamping, cold stamping, milling, punching and/or drilling or the like.

For example, there is the possibility that the at least two surface regions are configured to be hydrophilic and/or hydrophobic to degrees that differ from one another and in comparison to PEEK, a so-called amphiphilic configuration being possible as well. For example, one of the surface regions can be configured to be comparatively hydrophobic so that the retentivity for tartar is reduced there compared to untreated polyether ether ketone and compared to the second surface region, so that tartar deposition is reduced. The other surface region, e.g., can be configured to be comparatively hydrophilic so as to support protein deposition. There is also the possibility that at least two surface regions have surface activation that differs from one another and in comparison to PEEK, e.g., different activations effected by means of plasma jet ion treatment. Also, there is the possibility that the at least two surface regions have surface energies that differ from one another and in comparison to PEEK. The surface energy, also referred to as surface tension, can be changed, e.g., by means of plasma treatment, a higher surface tension tending to result in better wettability with other substances, thus, in this respect, resulting in a higher retentivity. The surface retentivity can also be influenced by the extent of surplus of positive or negative charge carriers that a surface has.

The invention also relates to a method for working on or producing a crestal implant, i.e., a dental implant, which in first instance provides that an implant is provided or produced which implements one or more of the features from the invention. In this respect, this may also be referred to as an implant blank or an implant body. According to the invention, the method proposes that the implant is shortened in the longitudinal direction at individual or a plurality of places, and/or the ribs thereof and/or the projections thereof are worked on. The method allows in particular that prior to the insertion into the jaw, the implant can be geometrically adapted to anatomical conditions of the jaw by a practitioner. Such working or adapting of conventional implants made of metal or titanium was not conceivable for a person skilled in the art, as it could result in destruction of the material structure and the risk of corrosion. In order to improve this method and/or this use, there is the possibility that shortening in the longitudinal direction takes place by means of cutting off implant parts, preferably in the basal and/or crestal region, it preferably being provided that the foot end is cut off, and/or that the core is cut through so as to cut off one or more rib groups, and/or that one or both conical length portions are cut off and/or ground. Also, there is the possibility that ribs, for which in each case a radial distance between the outermost rib edge and the geometrical longitudinal center axis is greater than the radial reference distance, are ablated and/or shortened from their free ends and/or edges, preferably for the purpose of adapting the implant to the diameter of a bore channel present in a jaw. There is also the possibility that the projections are shortened and/or weakened or removed, preferably by ablating or cutting off the projections by means of a cutting instrument. When using plastics or polyether ether ketone as an implant material, working on the implant can take place, e.g., by means of separation methods (e.g. cutting), machining processes (e.g. milling) or, e.g., by means of grinding.

For improving the method or the use, there is the possibility that a first surface region of a dental implant region, the implant material of which consists of polyether ether ketone or at least contains polyether ether ketone, and at least a second surface region of a dental implant region, the implant material of which consists of polyether ether ketone or at least contains polyether ether ketone, are in each case prepared by means of mechanical and/or physical and/or chemical action, so that at least one surface property of the surface resulting from the preparation of the first surface region differs, at least in certain regions, in terms of its characteristic from this surface property of the surface resulting from the preparation of the second surface region, and the characteristic of this surface property at these surfaces resulting from the preparation differs, at least in certain regions, from the characteristic of the surface property of their respectively associated surface region prior to or without the preparation, it being possible that this surface property preferably, but not necessarily essentially, is the surface retentivity of the dental implant for at least one natural or administered substance or type of body cells possible in a dental implant environment in an oral cavity. With respect to the effects and advantages possible in this regard and by means of the preferred refinements described hereinafter, reference is made to the description above. Various possibilities for preferred refinements also arise.

The deposition and/or the plasma treatment can be carried out either after shaping the dental implant is completed or largely completed, and/or after or during a local change in shape of the dental implant. There is the possibility that the surface shape of at least a portion of the prepared surface region is changed prior to or during the deposition of the substance and/or the plasma treatment, whereby this may be carried out, e.g., by means of hot stamping, cold stamping, milling, punching and/or drilling. There is the possibility to heat the thermoplastic material polyether ether ketone (PEEK) on the surface and to introduce nanoparticles into the heated surface, or to heat the nanoparticles or microparticles and attach them to the PEEK surface by such a fusing/soldering process. This can already take place, e.g., either during the industrial production of the dental implant blank, or can be carried out by a dentist after he has formed the implant (crestal or basal) according to the individual patient requirements. A dentist, e.g., could first create hollow spaces/recesses and pores and then fill them, i.e., deposit one or more substances in these cavities at the surface regions. Alternatively, during the production or finishing of the implant, in particular by a practitioner, the implant surface could be reshaped in only a single process and the substance deposition could be carried out at the same time. Also, the remaining or above-described implant features or measures could be carried out not only industrially, but advantageously also by practitioners and dentists themselves when making a dental implant or during the finishing of an implant blank itself.

The at least two surface regions can be configured, e.g., to be hydrophilic and/or hydrophobic and/or amphiphilic, to degrees that differ from one another. There is also the possibility that the at least two surface regions are activated differently from one another. Finally, the method can be carried out in such a way that on the at least two surface regions, surface energies are engendered that differ from one another.

### BRIEF DESCRIPTION OF THE DRAWINGS

The invention is further described below with reference to accompanying figures, which show preferred exemplary embodiments of the implant according to the invention. In the figures:

FIG. 1 shows in enlarged perspective an implant according to the invention according to a first exemplary embodiment;

FIG. 2 shows a front view of the foot end in the viewing direction II according to FIG. 1;

FIG. 3 shows a side view in the viewing direction III according to FIG. 2;

FIG. 4 shows a side view in the viewing direction IV according to FIG. 2;

FIG. 5 shows a sectional view along the sectional plane V-V according to FIG. 2, limited to the anchoring portion and the transition portion;

FIG. 6 shows a sectional view along the sectional line VI-VI according to FIG. 2, likewise limited to the anchoring portion and the transition portion;

FIG. 7 shows a side view of the implant according to FIGS. 1 to 6, illustrating, by means of separating lines, different possibilities for shortening the implant, by way of example;

FIG. 8 shows a sectional view of an implant according to FIGS. 1 to 7 in an example of an application prior to the insertion into a jawbone;

FIG. 9 shows the illustration of a later point in time shortly after crestal insertion of the implant into the bore channel;

FIG. 10 shows the arrangement according to FIG. 9 at a later point in time;

FIG. 11 shows a sectional view along the sectional line XI-XI according to FIG. 10;

FIG. 12 shows the arrangement according to FIG. 10, but after grinding the implant stump and after securing a dental crown to the ground tooth stump or prosthetic stump;

FIG. 13 shows a second preferred example of use of an implant according to the invention and according to a preferred exemplary embodiment, prior to mounting an artificial tooth;

FIG. 14 shows in perspective an implant according to the invention and according to a second preferred exemplary embodiment;

FIG. 15 shows a front view of the foot end in the viewing direction XV according to FIG. 14;

FIG. 16 shows a sectional view along the sectional line XVI-XVI from FIG. 15, limited to the anchoring portion and to the transition portion;

FIG. 17 shows a sectional view along the sectional line XVII-XVII from FIG. 15, likewise limited to the anchoring portion and the transition portion;

FIG. 18 shows a further possible example of use of the implant according to the second preferred exemplary embodiment; and

FIG. 19 shows a further possible exemplary embodiment of the implant according to the invention.

### DETAILED DESCRIPTION OF THE INVENTION

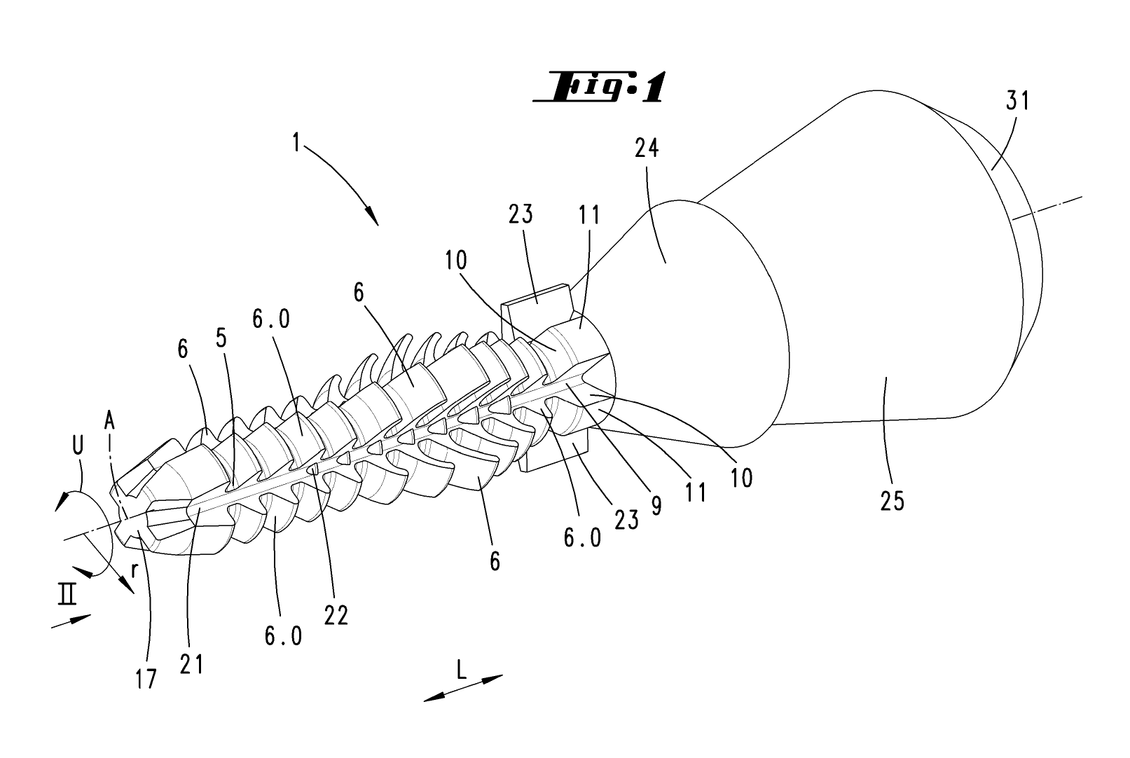

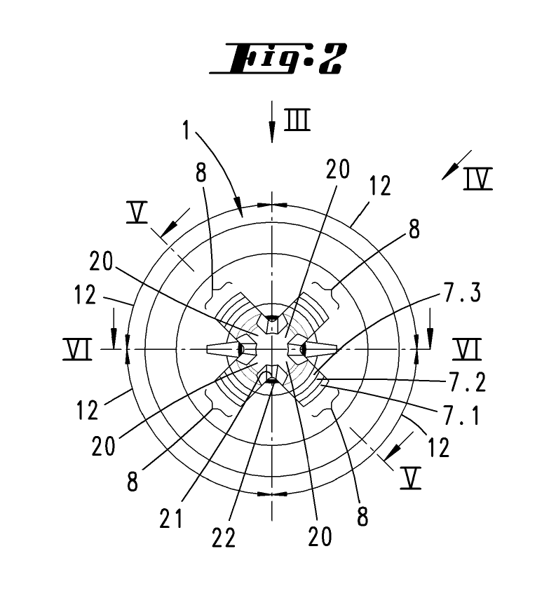

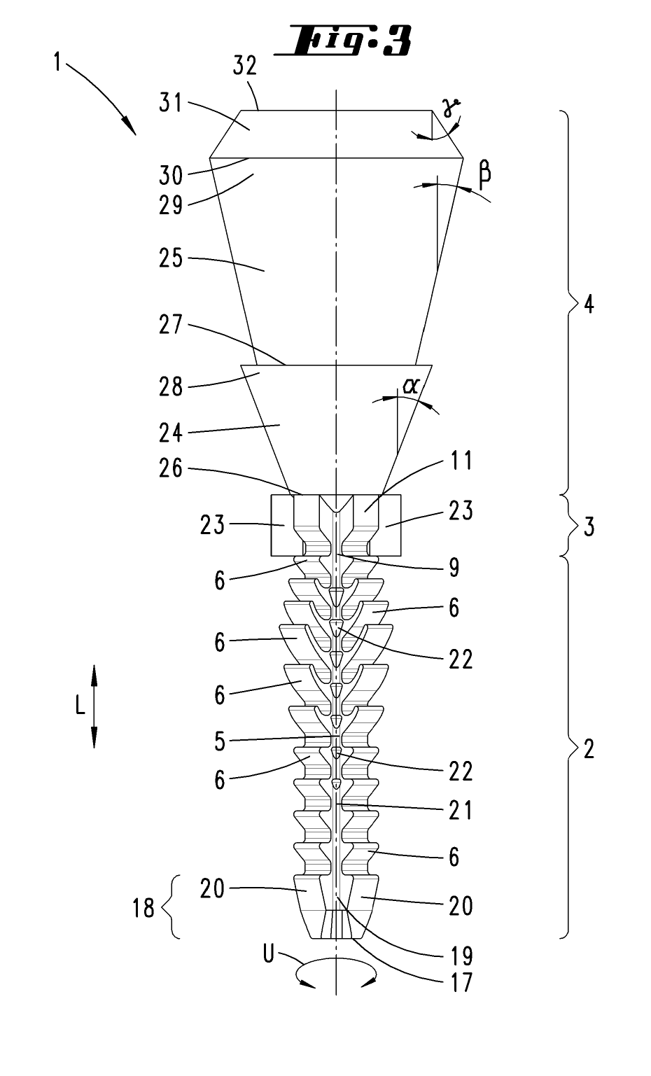

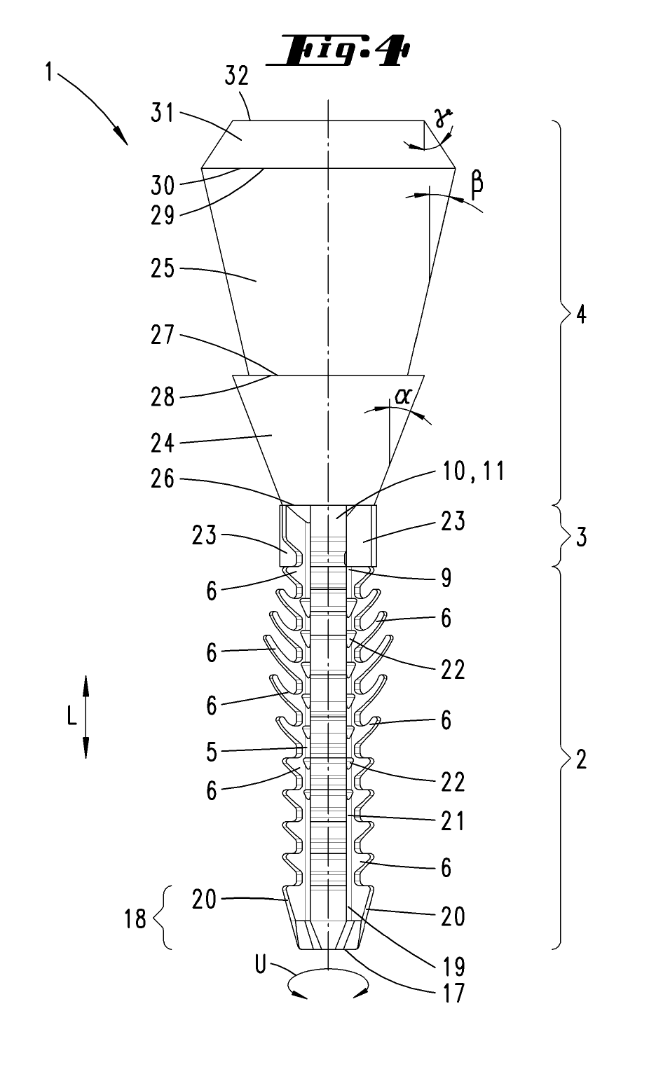

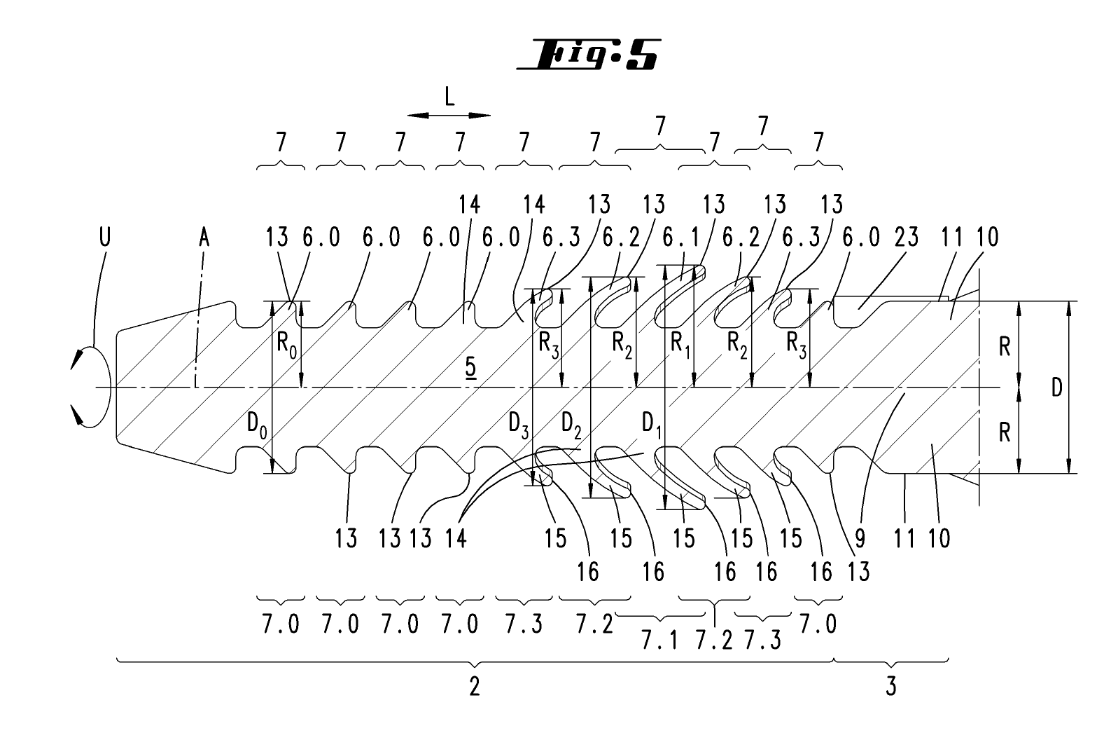

An implant 1 according to the invention and according to a first preferred exemplary embodiment is presented in first instance with reference to the FIGS. 1 to 6. The implant 1 shown is made as a whole as one piece from the plastics material polyether ether ketone (PEEK), the modulus of elasticity of which corresponds approximately to the modulus of elasticity of jawbone material. The implant 1 comprises an anchoring portion 2 which extends in its longitudinal direction L i.e., along its geometrical longitudinal center axis A, and with which the implant 1 can be inserted in the crestal direction, i.e., from the jaw crest, into the bore channel of a jawbone and can be anchored therein so that the implant 1 is fixedly held therein in the longitudinal direction L and is able to withstand the loads that occur. Furthermore, the implant 1 comprises a transition portion 3 which in the longitudinal direction L is adjoined by the anchoring portion 2, and which, again in the longitudinal direction L, is adjoined by an implant stump 4. The anchoring portion 2 has an elongate core 5. Numerous ribs extend from this core which, in first instance, are uniformly designated by the reference number 6. As in particular illustrated in FIG. 1, numerous ribs 6 are distributed on the anchoring portion in the longitudinal direction L and in a peripheral direction U extending around the geometrical longitudinal center axis A. The connection cross-sections of the ribs 6 on the core 5 (cf. base 14) are approximately equidistantly spaced apart from one another in the longitudinal direction L and in the peripheral direction U. Ribs 6, which jointly extend from a geometrical core cross-section that is planar in itself and perpendicular to the longitudinal center axis A, and which are distributed in the peripheral direction U on the core periphery of the core cross-section, are in first instance also uniformly referred to as rib group 7, the meaning of the reference numbers in FIG. 5 in groups being indicated by the use of brackets. On the other hand, ribs 6 which are disposed on the core 5 in the same peripheral angle position relative to one another, but are disposed one after the other in the longitudinal direction L, are jointly designated as rib row 8, as indicated in FIG. 2 by corresponding brackets. Accordingly, the example shows four rib rows 8. The ribs 6 extend from the core 5 in the radial direction r, i.e., radially outwardly. The transition portion 3 also comprises a core 9 that extends in straight extension from the core 5. In the example, four peripheral segments 10 extend radially outwardly from the core 9, which peripheral segments are distributed in the peripheral direction U and are disposed spaced apart from one another, and the radially outer surfaces 11 of which extend at a radial reference distance R from the geometrical longitudinal center axis A and thereby in the peripheral direction U and in the longitudinal direction L along an imaginary cylindrical enveloping surface. In the example, the four peripheral segments 10 are uniformly distributed in the peripheral direction U and are each situated centrally in one of the four peripheral angle intervals 12 which are marked in FIG. 2 and each of which spans a peripheral angle of 90°, without filling these intervals in the peripheral direction. Thus, in each case two surfaces 11 are situated diametrically opposite from one another on the periphery of the core 9, so that the transition portion 3 has there an effective reference diameter D in a manner of speaking. When the implant is used, this diameter, for example, can be equal to or slightly less than the diameter of a drill by means of which a bore channel which fits the implant is drilled into a jawbone in the crestal direction, i.e., from the jaw crest.

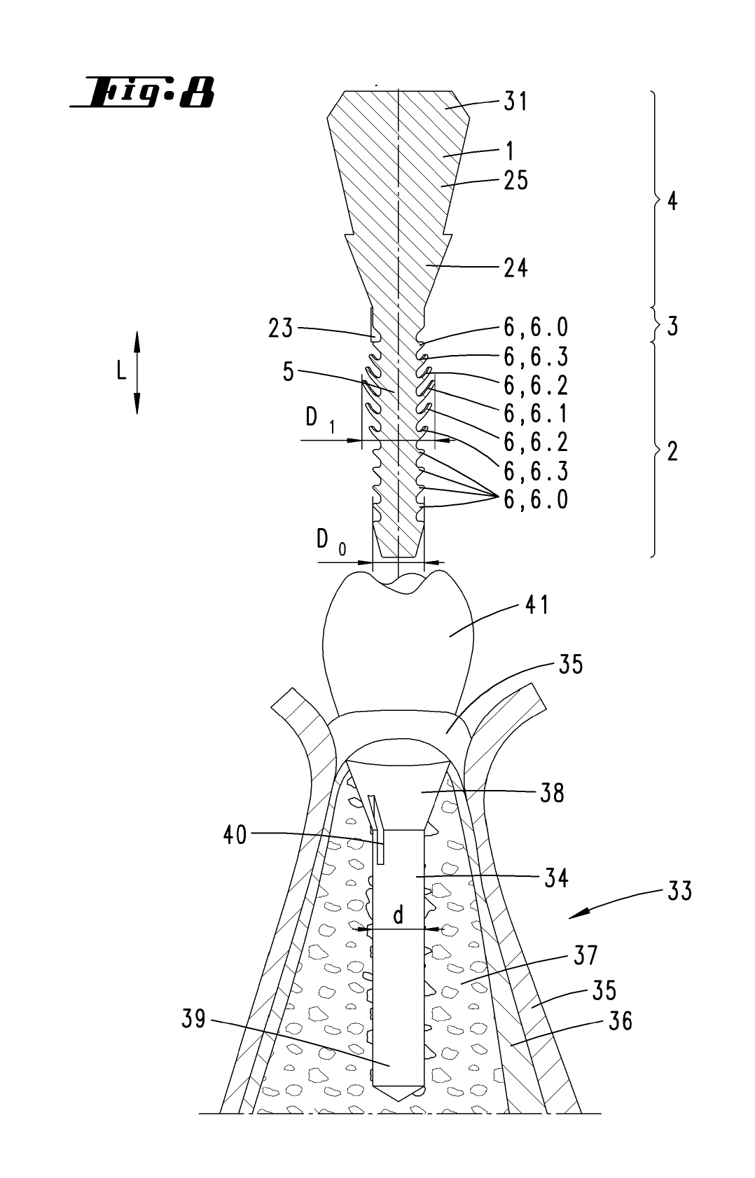

FIG. 5 shows that the implant 1 in the example has a total of five rib groups 7.0, for all ribs 6.0 of which the radial distance R₀ between the radially outermost rib edge 13 (the reference number 13 is uniformly used also for the rib edges of all remaining ribs 6), and the geometrical longitudinal center axis A of the implant 1 corresponds in each case to the radial reference distance R. In addition, rib groups 7.1, 7.2 and 7.3 are provided, all ribs 6.1, 6.2 and 6.3 thereof in the example having in each case a radial distance R₁, R₂ and R₃, respectively, between the radially outermost rib edge 13 and the geometrical longitudinal center axis A, that is greater than the radial reference distance R. The term “radial distance” refers to the radial distance, i.e., the distance in the radial direction r from the geometrical longitudinal center axis A. The radial reference distance is the radial distance, i.e., the distance in the radial direction, of the surfaces 11 from the geometrical longitudinal center axis A. As FIG. 8 illustrates, all ribs are uniformly designated by the reference number 6, and are each additionally designated by one of the reference numbers 6.0, 6.1, 6.2 or 6.3 in order to differentiate them from one another. This applies in the same way to the rib groups 7, i.e., to the reference numbers 7.0, 7.1, 7.2, 7.3 (cf. FIG. 5) that serve for differentiation, and to the radial distances R, i.e., R₀, R₁, R₂, R₃ and diameters D, i.e., D₀, D₁, D₂, D₃, associated with the ribs. These numerals thus also facilitate the association of radial distances and diameters with certain ribs and rib groups, it being also possible to use letters (e.g., 6, 6a, 6b, 6c, 6d instead of 6, 6.0, 6.1, 6.2, 6.3) for differentiation instead of the numerals (with a period suffix). As illustrated in FIG. 2, in the example the radially outermost rib edge 13 of all ribs 6 extends along geometrical or imaginary circular lines that are concentric with the geometrical longitudinal center axis A; i.e., the rib edges 13 have a constant radial distance from the longitudinal center axis A in the peripheral direction U. FIG. 2 shows that each rib group 7 includes four ribs 6, each of which are also disposed centrally in each one of the peripheral angle intervals 12, so that in two transverse directions that are perpendicular to one another and extend through the geometrical longitudinal center axis A, two ribs 6 are situated diametrically opposite from one another on the periphery in each rib group 7. Thus, each rib group 7 can be assigned a joint effective diameter, the diameter D₀ corresponding to twice the radial distance R₀, the diameter D₁ to twice the radial distance R₁, the diameter D₂ to twice the radial distance R₂, and the diameter D₃ to twice the radial distance R₃. In the selected exemplary embodiment, initially a rib group 7.0 is connected to the transition portion 3 in the longitudinal direction. Connected to this rib group in the longitudinal direction L are, in sequence, a rib group 7.3, a rib group 7.2, a rib group 7.1, a further rib group 7.2, a further rib group 7.3, and again a plurality, four in the example, of rib groups 7.0. The rib groups 7.1, 7.2 and 7.3 differ from group to group in their radial distance R₁, R₂ and R₃, respectively. A first rib group 7.1, which is present only once, is associated with a so-called first, maximum radial distance R₁ on the implant 1 of the outermost rib edges 13 from the longitudinal center axis A. In the longitudinal direction L, on both sides of the rib group 7.1, in each case one so-called second rib group 7.2 is disposed, which is associated in each case with a so-called second radial distance R₂ of the rib edges 13 from the longitudinal center axis A, which second radial distance is less than the first radial distance R₁ and greater than the radial reference distance R. Each of the two so-called third rib groups 7.3, each of which is located on the side of the rib group 7.2 that faces away from the rib group 7.1 in the longitudinal direction L, is associated with a so-called third radial distance R₃ of the radially outermost rib edges 13 from the longitudinal center axis A. In the selected example, the radial distance R₁ is greater than the radial distance R₂, the radial distance R₂ is greater than the radial distance R₃, and the radial distance R₃ is greater than the radial distance R₀, which corresponds to the radial reference distance R. FIG. 5 shows that in a cross-sectional plane that extends through the geometrical longitudinal axis A, the ribs 6.0, 6.1, 6.2 and 6.3 also have cross-sections that differ from one another. The ribs 6.0 have a substantially triangular cross-section with a rounded apex. Since the flank of this cross-section, which flank faces the transition portion 3, extends approximately perpendicular to the longitudinal axis A and the opposite flank extends inclined thereto, this results in a substantially sawtooth-like cross-sectional profile with a rounded profile peak. The rib cross-section of the ribs 6.0 does not protrude laterally in the longitudinal direction L beyond the wide base 14 of the ribs 6.0, which base adjoins the core 5. For simplification, the reference number 14 is also used for the base of the ribs 6.1, 6.2 and 6.3, i.e., for all ribs 6. Starting from this base, for each of the ribs 6.1, 6.2 and 6.3 in the example, a cross-section (although deviating from one another between the different groups) is selected which differs from the ribs 6.0 and which, extending from a base 14 adjoining the core cross-section, tapers in each case into an elongate extension 15 which has an approximately constant cross-sectional thickness in a length portion adjoining in each case the free longitudinal end of the cross-section, i.e., the radially outer rib edge 13. To provide a better overview, the reference number 15 is also uniformly used for each of the different rib groups 7. The elongate extension 15 extends not only in the radial direction r, but toward its free longitudinal end 16, also extends in the direction toward the transition portion 3. In the selected example, the extensions 15 extend in a longitudinal direction which encloses an acute angle of inclination of approximately 45° with the geometrical longitudinal axis A which runs centrally through the core 5.

At the free longitudinal end of the anchoring portion 2, the implant 1 comprises a foot end 18 that has a core 19 and has a cross-section that tapers toward the free longitudinal end 17. In the example, four foot segments 20 that are equidistantly spaced in the peripheral direction U extend radially outwardly from the core. In each case, one foot segment 20 is situated centrally in the peripheral direction in each of the peripheral angle intervals 12, again without filling this angle interval in the peripheral direction. Thus, in the extension of each rib group 8, which extension is straight with regard to the longitudinal direction L, at the one longitudinal end of the rib group there is a peripheral segment 10 of the transition portion 3, and at the opposite longitudinal end thereof there is a foot segment 20 of the foot end 18. Between adjacent rib rows 8, between adjacent peripheral segments 10, and between adjacent foot segments 20, there is in each case a fillet 21 that has a concavely rounded cross-section and runs straight through in the longitudinal direction L, in each fillet a stiffening projection 22 being embedded between adjacent ribs of some (not all) of the rib groups.

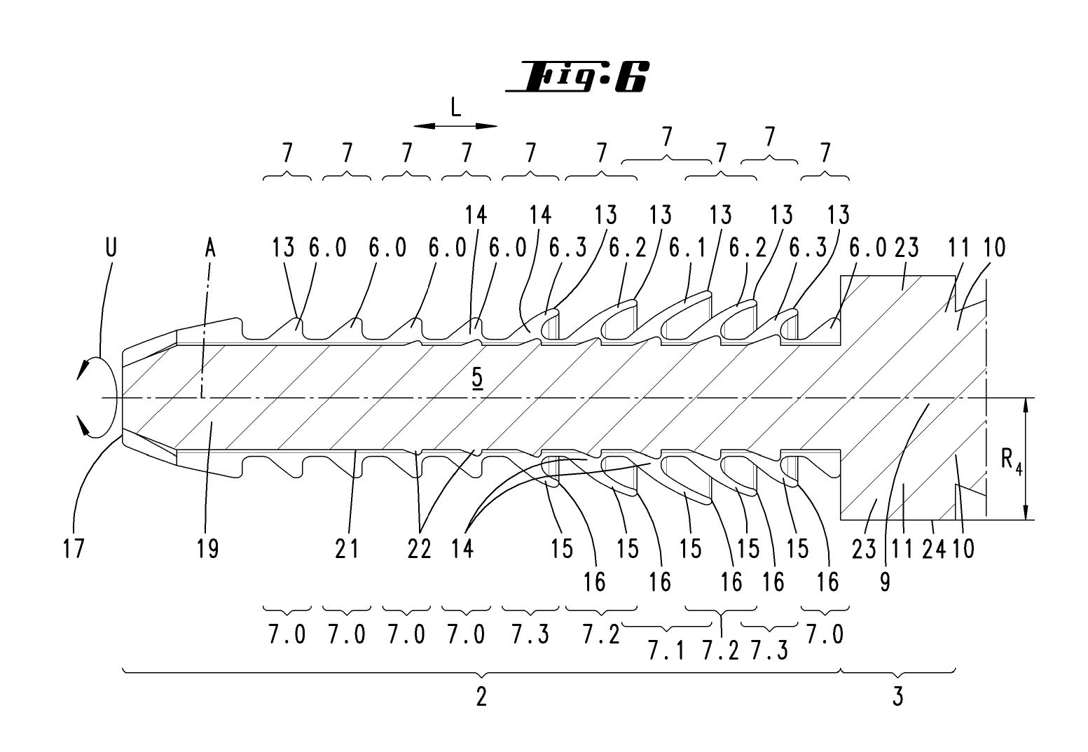

At the transition portion 3 on the periphery thereof, two projections 23 are formed which are situated diametrically opposite from one another. Starting from the core 9, each projection 23 extends radially outwardly between two directly adjacent peripheral segments 10 and beyond the surfaces 11. The radial distance R₄ (cf. FIG. 6) between the narrow outer surface 24 extending in the longitudinal direction L and the longitudinal center axis A is greater than the radial reference distance R and, in the example, corresponds approximately to the radial distance R₁. In a cross-sectional plane perpendicular to the longitudinal center axis A, the projections 23 have a wedge-shaped cross-section that tapers radially outwardly, and in a cross-sectional plane that extends through the geometrical longitudinal axis A they have a rectangular cross-section.

In the example, the implant stump 4 as a whole is formed rotationally symmetrically with regard to the geometrical longitudinal axis A. The implant stump 4 comprises two conical length portions 24, 25, of which the first length portion 24 is connected as one piece via its tapered longitudinal end 26 to the transition portion 3, and of which the second conical length portion 25 is connected via its tapered longitudinal end 27 as one piece or integrally to the widened longitudinal end 28 of the first length portion 24. The tapered longitudinal end 27 has a greater diameter than the tapered longitudinal end 26, and the widened longitudinal end 29 has a greater diameter than the widened longitudinal end 28. The widened longitudinal end 29 coincides with a widened longitudinal end 30 of the third conical length portion 31, the tapered longitudinal end 32 of which forms a free end face of the implant 1. In terms of the absolute value, the taper angle γ of the third conical length portion 31 is greater than the taper angle α of the first conical length portion 24, and the latter, in turn, has a greater absolute value than the taper angle 13 of the second conical length portion 25. The three conical length portions 24, 25 and 31 are formed concentrically with regard to the geometrical longitudinal center axis A of the implant 1.

As already mentioned, the figures show an enlarged illustration of the implant 1 according to the invention and according to a first preferred exemplary embodiment selected for this purpose. In the example selected for FIGS. 1 to 6, i.e., not necessarily essentially, in the longitudinal direction L (which runs parallel to the geometrical longitudinal center axis A), the anchoring portion 2 has a length of approximately 12 mm, the transition portion 3 has a length of approximately 2 mm and the implant stump 4 has a length of approximately 12 mm. In the example, the radial distance R₀ and, for example, also the radial reference distance R, is 1.45 mm, the radial distance R₁ is 1.65 mm, the radial distance R₂ is 1.85 mm and the radial distance R₃ is 2.05 mm, the diameters D₀, D, D₁, D₂ and D₃ associated with these radial distances each having twice these values. Thus, in the sequence 7.1, 7.2, 7.3 and 7.0 of the rib groups, a radius or diameter change is implemented that is constant from rib group to rib group. In the example, the diameter of the core 5, 9, 19 is 0.7 mm. The radial distance R₄ is 2.05 mm. In the example, the length of the first conical length portion 24, again measured in the longitudinal direction L, is 4 mm, the length of the second conical length portion 25 is 6.5 mm and the length of the third conical length portion 31 is 1.5 mm. The widened end cross-section 28 of the first length portion 24 has a diameter of 6 mm, the widened end cross-section 29 of the second length portion 25 has a diameter of 8 mm, and the tapered end cross-section of the third conical length portion 31 has a diameter of 6 mm. However, it is to be understood that all aforementioned dimensions and proportions have been selected only by way of example, and that deviations therefrom are possible.

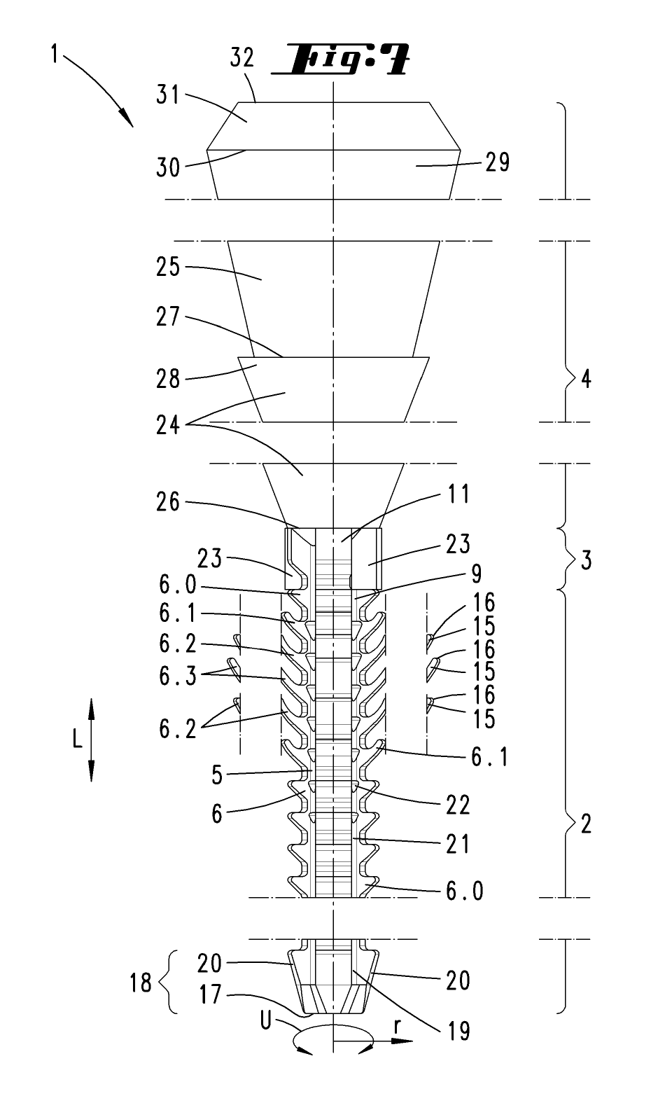

With reference to FIG. 7, it is schematically illustrated for the crestal implant 1 selected as an example how this implant can be geometrically adapted by a user to different anatomical conditions. Thus, for example, the extensions 15 of the ribs can be shortened on individual or a plurality of the rib groups 7.1, 7.2, 7.3 so as to influence the maximum quasi-effective diameter present in the anchoring portion 2. For example, it is possible to shorten only the ribs 6.1 to such an extent that their radial distance corresponds to the radial distance R₂ of their adjacent ribs 6.2, so that the maximum effective diameter of the anchoring portion 2 would then be D₂. In FIG. 7 it is shown by way of example that the extensions 15 of the ribs 6.1 and 6.2 can be shortened to an extent that the radial distance of the ribs 6.1 and 6.2 corresponds to the radial distance R₃ of the adjacent ribs 6.3. It is to be understood that the extensions 15 of all ribs 6.1, 6.2 and 6.3 can also be shortened. so that subsequently their radial distance of the rib edges uniformly corresponds to the radial distance R₀, i.e., to the radial reference distance R. In this manner, the implant 1 can be adapted to bore channels with different diameters. Also, the projections 23 can be shortened as needed or can be removed completely. Should a further diameter reduction still be desired, it is additionally possible to shorten also the ribs 6.0 in the radial direction and, if necessary, to substantially or completely remove them. A geometrical adaption can also take place in the longitudinal direction L. In particular, by cutting off implant parts, the implant 1 according to the invention can be shortened to different desired lengths of different conventional implants. The implant 1, which in the example has a total length of 26 mm, can be shortened, e.g., to 13 mm so that, e.g., it could be inserted into an available jaw crest depth of 8 mm, for example. In this case, the implant, e.g., could be countersunk in the bone with a depth of 8 mm, and 5 mm of the length could protrude from the bone into the oral cavity so as to accommodate a crown. The implant 1 described as an example can be countersunk in the bone to a depth between 8 mm and 21 mm and in any desired height. Here, the bone may have a width between 2.9 mm and 9 mm. The collar region can be reduced, e.g., from 8 mm to 2.8 mm without causing biomechanical disadvantages. With the cutting edges marked in FIG. 7 it is indicated that, if needed, the foot end 18 can be cut off and/or the implant stump 4 can be shortened. By cutting off the foot part 18, the implant 1 can also be shortened in its basal region. However, a person skilled in the art will understand that the implant 1 could also be shortened in its crestal region adjoining the basal region in the longitudinal direction L. For example, one or more of the rib groups 7.0 that are adjacent to the foot end 18 could be additionally cut off; if needed, cutting off one or more of the rib groups 7.1, 7.2, 7.3 would also be possible. Based on the description above, it becomes clear that the implant 1 according to the invention advantageously enables replacement of the average number of approximately ten implant variants, which are required with respect to conventional implants and are typically offered by suppliers of metal implants, by only a single implant 1 according to the invention which can be adapted to the anatomical requirements.

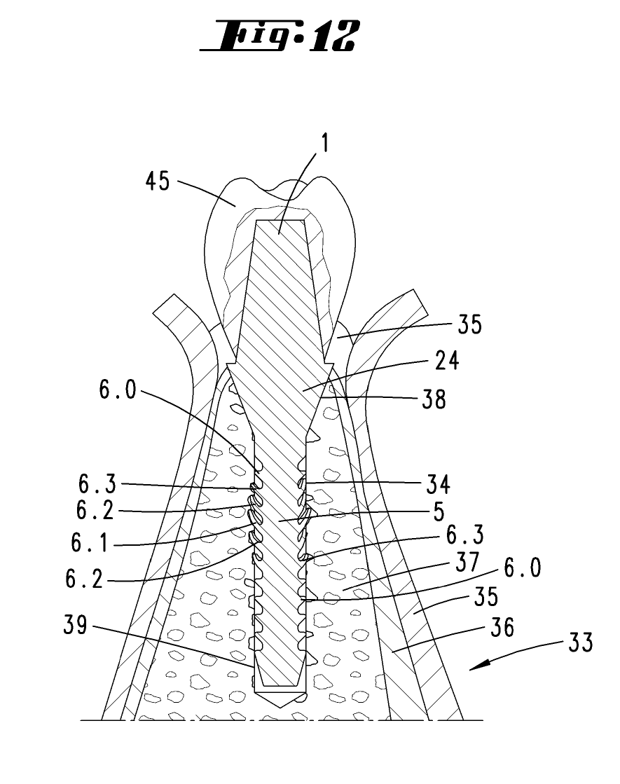

With reference to the FIGS. 8 to 12, a possible use of the implant 1 according to the invention and according to the first preferred exemplary embodiment described with reference to the FIGS. 1 to 7 is presented as an example. FIG. 8 shows the implant 1 prior to the insertion into a bore channel 34 prepared for this purpose in a jawbone 33. Here, reference number 35 designates the gums, 36 designates the comparatively harder bone edge and 37 designates the comparatively softer, slightly porous bone interior 37. The bore channel 34 extends with a constant diameter d (cylinder bore 39) from its bottom in a length portion assigned to the anchoring portion 2 up to a conically widening bore opening 38 which, in the example, serves to accommodate the first conical length portion 24. The contour of the bore opening 38 and the cylinder bore 39 is interrupted by two slot-like recesses 40 which are situated diametrically opposite from one another on the periphery and serve to accommodate the two projections 23. Designated by reference number 41 is a natural tooth which, in the viewing direction of FIG. 8, is situated behind the treatment site. In the selected example, the quasi-effective diameter D₀ associated with the ribs 6.0, and also the reference diameter D, correspond to the diameter d of the bore channel 34, so that the ribs 6.0 alone do not allow a fixed axial anchoring. However, the effective diameter D₁ associated with the ribs 6.1 and the rib group 7.1 is greater than the diameter d. The same applies, although to a slightly lesser extent, to the diameters D₂ and D₃ of the ribs 6.2 and 6.3 and the rib groups 7.2 and 7.3, respectively.

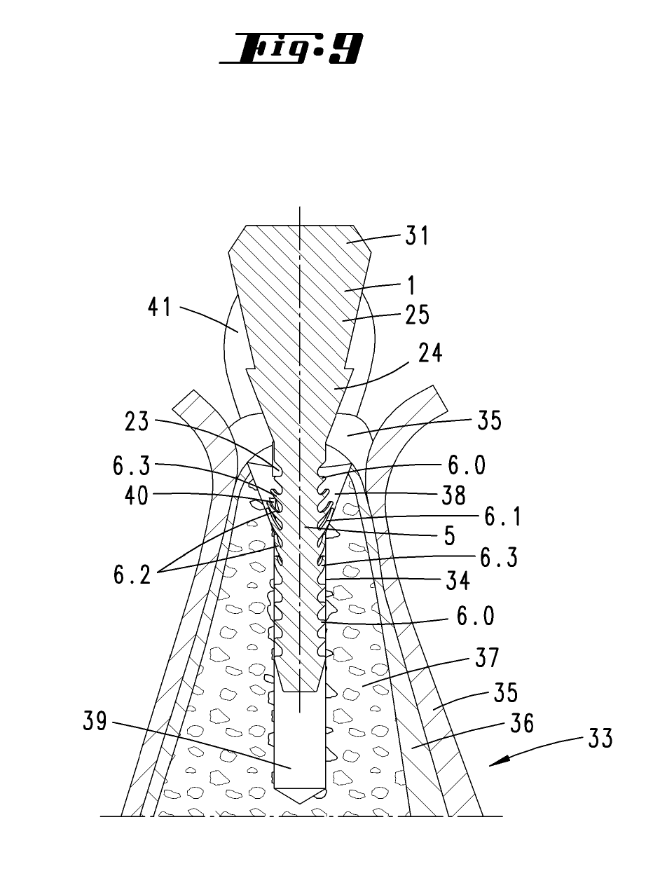

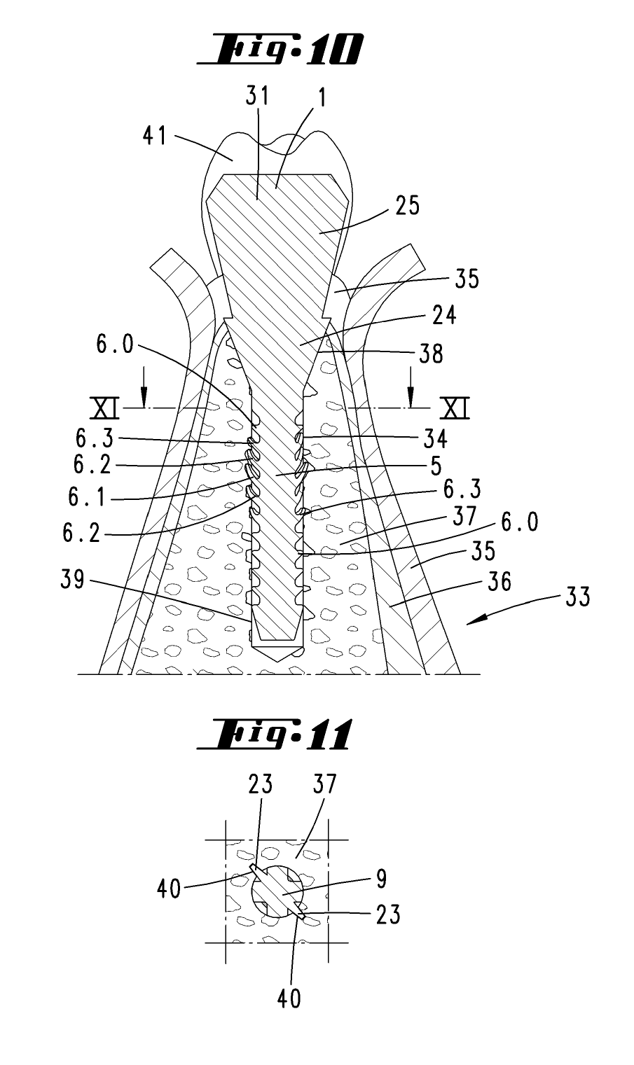

FIG. 9 shows that when the implant 1 is driven into the bore channel 34, the ribs 6.1, 6.2 and 6.3 therefore spring-elastically approach the core 5. In FIG. 10, the implant has reached its final position in the jawbone, and the ribs 6.1, 6.2 and 6.3 gradually unfold again without damaging bone cells by excessive pressure. Since the material of the implant 1 has the same modulus of elasticity as the surrounding bone, the bone determines the speed of unfolding. The unfolding ribs 6.1, 6.2 and 6.3 then prevent the implant from disengaging from the bore channel 34, so that no thread is required. The implant 1 is anchored in the surrounding bone in a dowel-like manner and is effectively secured against axial extraction. Inserting or driving the implant 1 into the bore channel 34 takes place in the crestal direction, i.e., from the jaw crest. In this respect, the implant 1 according to the invention differs from implants that are inserted sideways or laterally into recesses in the jawbone. Since in the example, the first conical length portion has also been inserted into the jawbone 33, a desired aesthetic superstructure, e.g., a dental crown, can be secured to the second conical length portion 25.

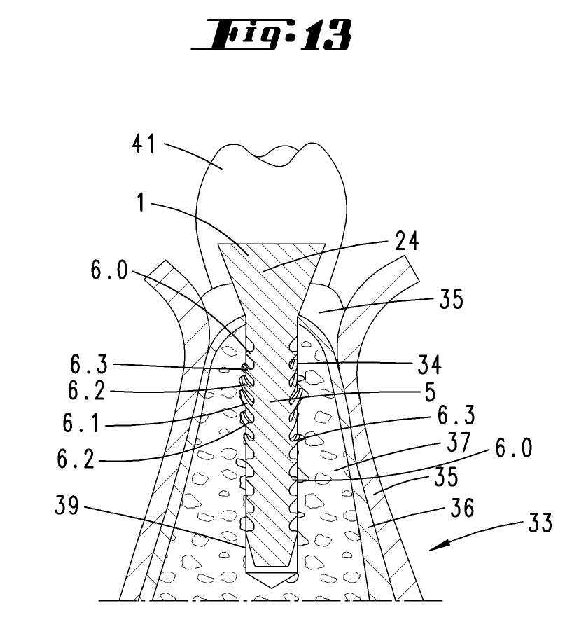

FIG. 12 shows that for this purpose, the previously conical length portion 25 has been ground so that this length portion, extending from the first conical length portion 24, tapers in the longitudinal direction L. The section shows that on this now comparatively slimmer and inverted cone, which forms a prosthetic stump, an artifical tooth 45 has been placed and secured thereto, the artifical tooth 45 being a crown which virtually corresponds to the shape of the adjoining teeth 41.

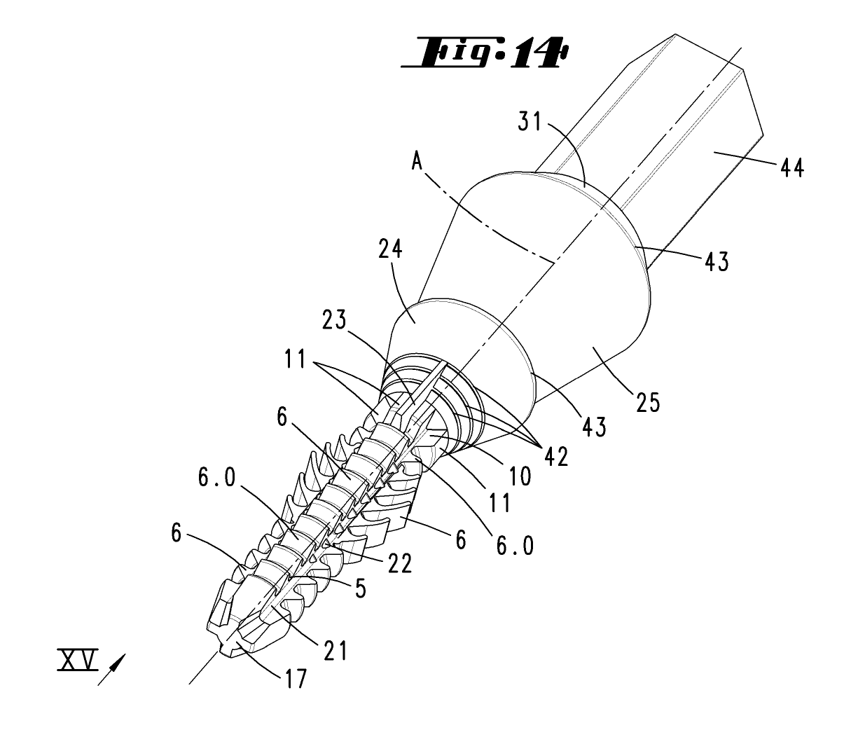

FIG. 13 shows a further preferred example of use of the implant 1 according to the invention. Deviating from FIGS. 8 to 11, the second conical length portion 25 of the implant 1 has been cut off. The remaining first conical length portion 24 has not been inserted into the jawbone 33, but instead protrudes over the jaw crest and into the oral cavity. Thus, in this example the first conical length portion 24 can serve for mounting and securing an aesthetic superstructure, which is not illustrated in FIG. 13, which serves as a denture and, for this purpose, is ground beforehand.

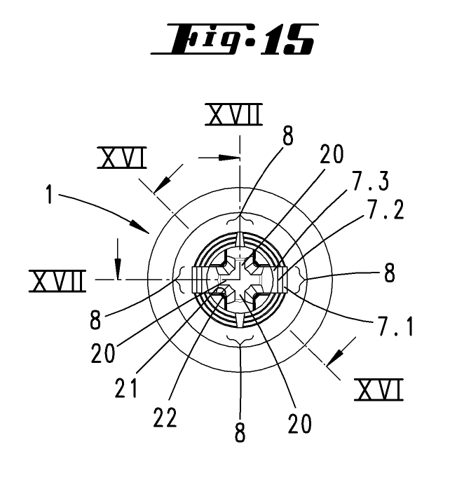

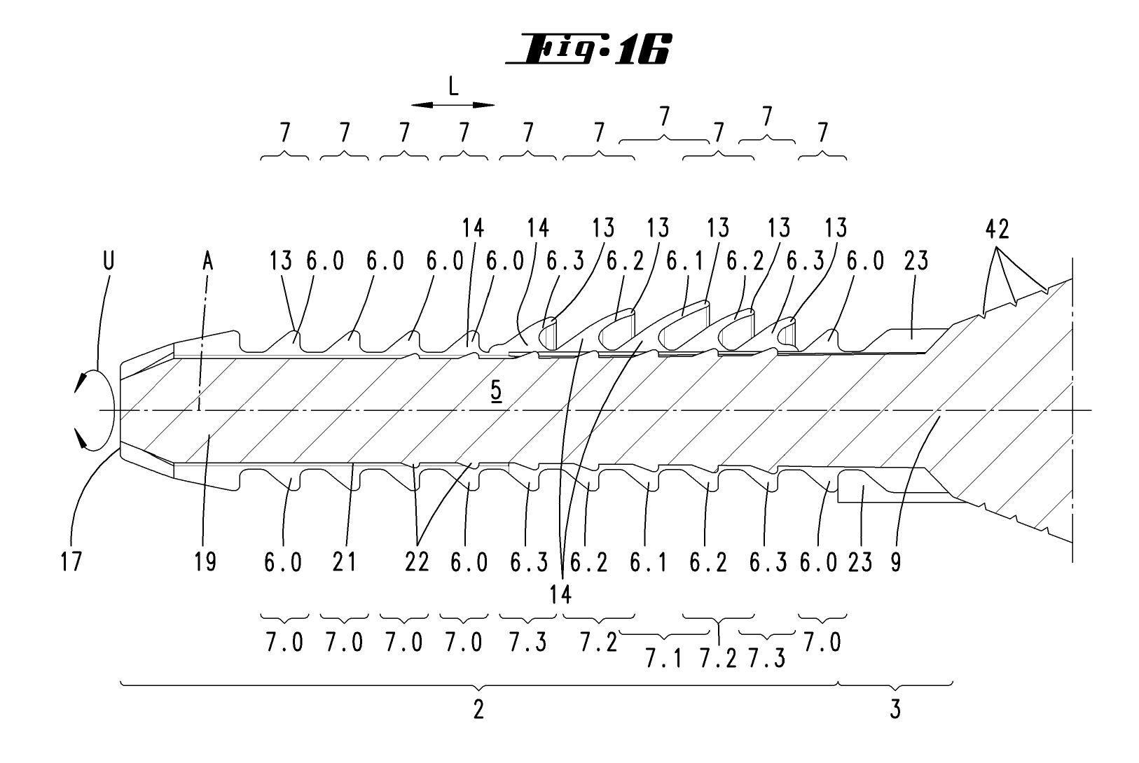

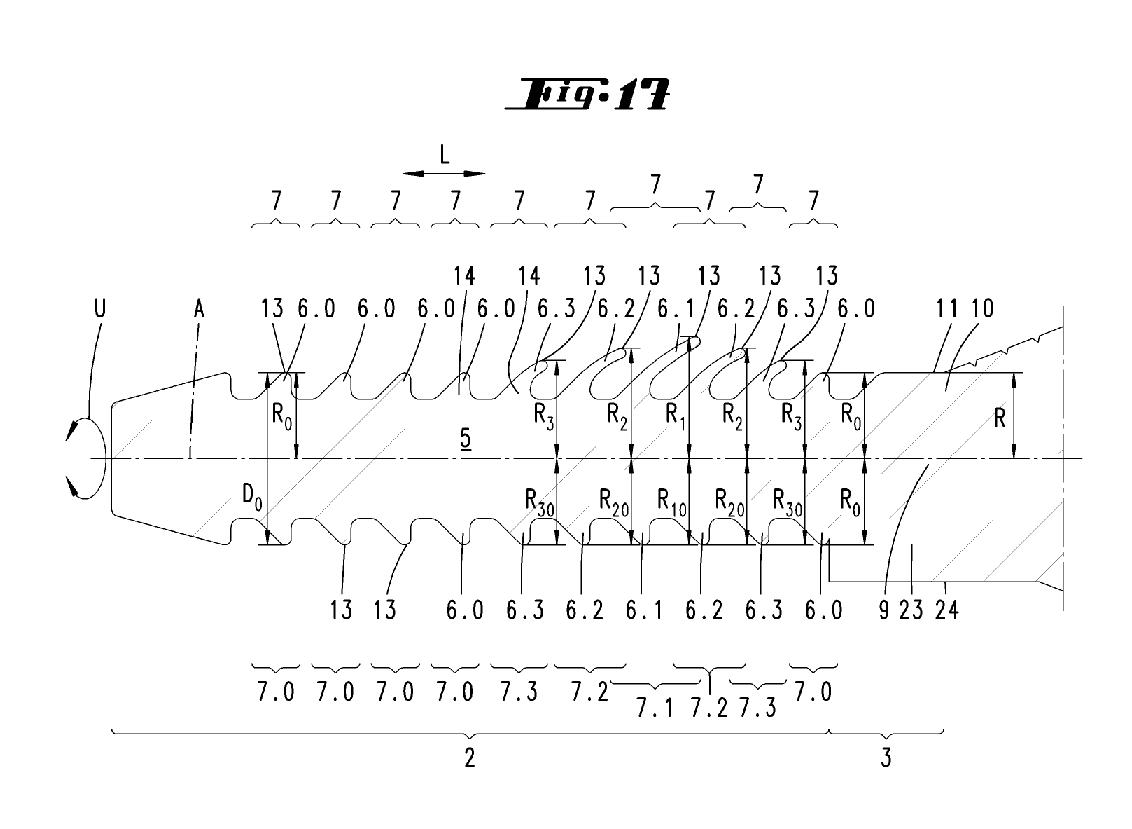

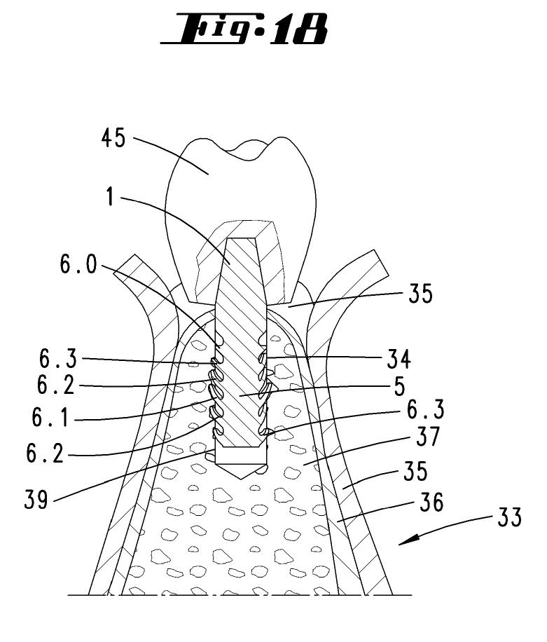

An implant 1 according to the invention and according to a second preferred exemplary embodiment is presented with reference to FIGS. 14 to 17. To avoid repetitions and to provide a better overview, details that correspond to the example in FIGS. 1 to 7 are denoted by the same reference number. The first and second length portions 24, 25 deviate slightly from a strict shape of a cone or truncated cone, in that on each of the widened longitudinal ends, circumferential curvatures 43 are provided, in that on the first length portion 24, three circumferential grooves 42 are provided which are spaced apart from one another, and in that the projections 23 extend in the longitudinal direction L up into the region of the first length portion 24. However, in this respect the length sections 24, 25 have a substantially conical shape. Another difference is that an attachment 44 adjoins the third, substantially conical, length portion 31 in the longitudinal direction L, which attachment is hexagonal in cross-section and the longitudinal extent of which is 5 mm in the example. This extension can serve in practice for receiving the implant 1, using a placing instrument that represents a similar hexagon cavity. After placing the implant into the bone, the attachment 44 can be cut off or can be utilized by the practitioner. Another deviation from the example in FIGS. 1 to 7 is that in the case of the rib groups 7.1, 7.2 and 7.3, not all ribs 6.1, 6.2, 6.3 have at their radially outer rib edge 13 a radial distance R₁, R₂, R₃ from the geometrical longitudinal center axis A that is greater than the radial distance R. In the example currently selected, it is provided that, although each rib group 7.1, 7.2, 7.3 in each case again has four ribs (again uniformly designated by 6.1, 6.2, 6.3), for each rib group only two ribs 6.1, 6.2, 6.3 situated opposite from one another on the core periphery have at their radially outer rib edge a radial distance R₁, R₂, R₃ from the geometrical longitudinal center axis A that is greater than the radial reference distance R, the two remaining ribs 6.1, 6.2, 6.3 having at their radially outer rib edge 13 a radial distance R₁₀, R₂₀, R₃₀ from the geometrical longitudinal axis A that corresponds to the reference distance R. Another deviation is that the edges 13 of ribs 6.1, 6.2 and 6.3, which have an extension 15, do not extend in the peripheral direction along a circular curve, but instead are flattened. The radial distances R₁₀, R₂₀, R₃₀ in the illustration relate to the middle of the ribs. In the example in FIGS. 1 to 7, the radial distance between the bottoms of two opposite fillets 21 was constant in the longitudinal direction L. In the example in FIGS. 14 to 17, it is provided instead that this distance slightly increases in the direction toward the transition portion 3. Also, the configuration of the transition portion 3 deviates from the first exemplary embodiment. The two projections 23 are not in straight extension of the two fillets 21, but, rather, are offset with respect to them by 45° so that they extend in the longitudinal direction through one each of the peripheral segments 10. The projections 23 can be shortened by a surgeon (depending on the anatomical requirement) and/or can be weakened, depending on the elastic requirement. In the rib groups 7.1, 7.2, 7.3, such ribs 6.1, 6.2, 6.3 with which the radial distance R₁₀, R₂₀ or R₃₀, respectively, is associated (cf. FIG. 17) can correspond in cross-section, e.g., to the ribs 6.0.

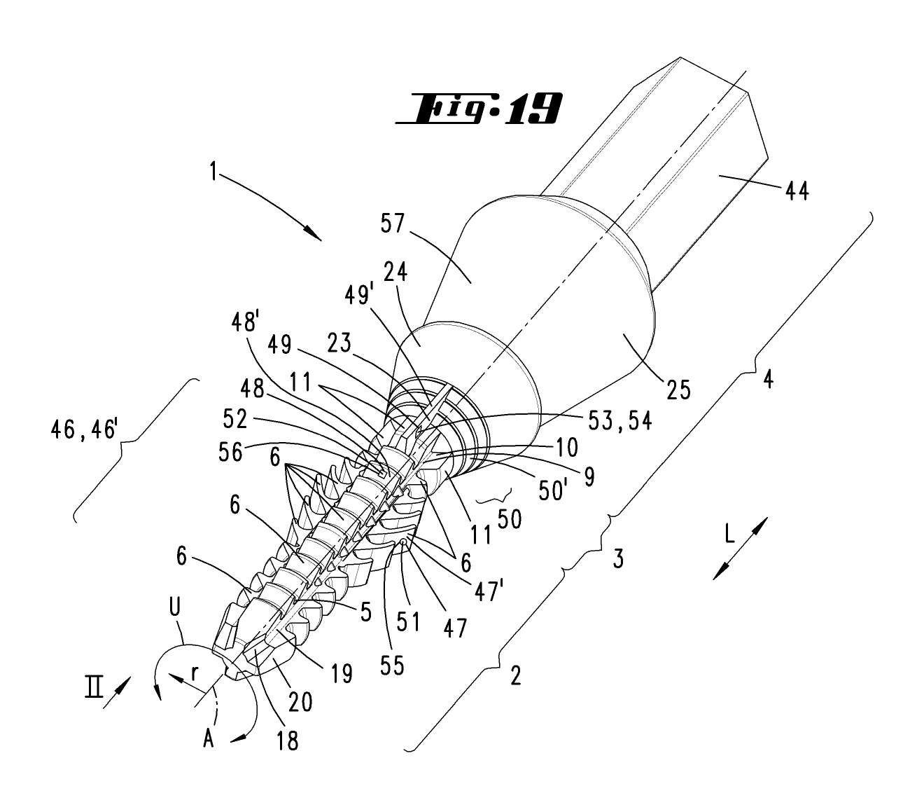

FIG. 18 shows a possible example of use for the implant 1 according to the invention and according to the preceding exemplary embodiments. The second length portion 25 has been cut off and the first length portion 24 has been ground to form a prosthetic stump. At the opposite longitudinal end, there has been axial shortening by cutting off the core 5 together with all rib groups 7.0 located thereon, so that the implant 1 can also be inserted into a jaw cross-section of lesser height. Accordingly, in comparison to the preceding figures, the implant 1 in FIG. 18 is inserted to only a lesser depth into the jawbone 33.

In the example in FIGS. 14 to 17, the tooth implant 1 is made completely from polyether ether ketone (PEEK). After the initial strictly shaping production process of the tooth implant 1, the surface thereof, designated in FIG. 19 as a whole by reference number 57, therefore initially still exhibits the known inert or nonreactive properties of this thermoplastic plastics material. Initially starting with such a dental implant 1 or dental implant blank, during finishing or for producing the dental implant 1 shown in FIG. 19, only the surface regions 46, 47, 48, 49 and 50 of the entire surface 57 have been prepared (either industrially or by a practitioner and/or a dentist) so as to modify in a correspondingly locally limited manner at least one surface property in each case at that location. This is explained in more detail hereinafter by means of individual examples.

The surface region 46 comprises the entire surface of the ribbed dental implant region 46′ in the anchoring portion 2. Only at this location, the surface has been activated by means of a plasma treatment using, e.g., helium or argon (a mixture with nitrogen can also be suitable). During this treatment, ions are separated from the polyether ether ketone so that free radicals are formed which facilitate a deposition in particular of nitrogen, hydrogen and oxygen ions, i.e., increase the surface retentivity, so that ultimately an easier deposition of proteins of the extracellular matrix of the tissue is also enabled and the tissue adherence is improved.

The surface region 47 is associated with one of the teeth 6 as a dental implant region 47′, and with comparatively smaller dimensions thus lies within the surface region 46. The curved surface region 47 has initially been reshaped by means of a through-hole passing through the rib 6, and in this respect has been mechanically prepared. A substance grain made of hydroxyapatite which is suitable in terms of shape and size has been pressed into this through-hole 55 so that it is held therein in a friction-locked manner. The substance contained in the substance grain 51 is thereby deposited on the surface of the dental implant, the shape of the surface being locally changed as a result, the substance grain itself also forming a surface which in this respect results from the preparation. The surface that results from the preparation of the surface region 47 and is situated on the substance grain 51 has a surface retentivity that deviates from polyether ether ketone.

The surface region 48 is located on another tooth 6 and has an angular contour. Therein, a certain amount of heated nanoparticles 52 from the substance selected for the preparation has been pressed against the rib 6, using a hot spatula. The nanoparticles of the substance have been deposited in a firmly bonding manner into the depression or pore 56 thereby melted into the thermoplastic polyether ether ketone.

The surface region 49 is in each case located at a dental implant region 49′ formed by one of the projections 20 in each case. The surface region 49 has been initially mechanically prepared by punching out a rectangular window therefrom as a continuous cut-out 53. In a subsequent preparation step, a chip 54 of suitable size has been pressed thereinto, the chip containing a substance with an active ingredient that is advantageous for this dental implant region 49′. The chip surface resulting from the preparation possesses surface properties that differ from PEEK.

The surface region 50 comprises the circumferential surface of the first conical length portion 24 extending from the transition portion 3 up to approximately half the length. The dental implant region 50 is thus a part of the first conical length portion 24. After the insertion of the dental implant into the jaw, the surface region 50 can typically lie in the region of the gums and the mucosa. The surface region 50 in the selected example has therefore been passivated by means of ionizing cold plasma at atmospheric pressure, using a gas suitable for passivating for the purpose of obtaining a negative surface. This can be achieved by splitting off H⁺ ions from polyether ether ketone so that a surplus of OH⁻ ions remains on the surface. The surface thus resulting from the preparation possesses different surface properties than the pure implant material. Alternatively, a surface resulting from a preparation can be, e.g., the surface of a coating on the dental implant formed from a substance. For the deposition, in particular liquid and/or solid and/or gaseous substances can be considered. Also, the surface resulting from a preparation can be, e.g., a surface composed of PEEK itself, which has been roughened during the preparation. Thus, in the example, a plurality of surface regions of the dental implant 1 have been prepared in ways that differ from one another, so that the surface retentivity of the surfaces resulting therefrom in each case differ from one another, and also differ in each case compared to the original surface retentivity of the surface regions associated with them.

It will be understood that there is a multiplicity of further possibilities for preparing surface regions. As already mentioned, it is possible that the projections 23 are not only shortened (depending on the anatomical requirement) or weakened (depending on the elastic requirement) by a surgeon, but as part of a mechanical preparation, they can also be provided with openings by punching or milling, and then allow insertion or encapsulation of substances which are advantageous for the ingrowth into the bone and/or accelerate this ingrowth (e.g., bone formation factors, bone morphogenetic protein, platelet-rich plasma, minerals in the form of beta tricalcium phosphate, hydroxyapatites), and/or antiseptics/antibiotics, in particular for preventing infections during the ingrowth into the bone. Openings such as “pores” can be introduced into a material such as polyether ether ketone at locations for accommodating substances, or for impregnation with substances, which are meaningful. For example, antiseptics can be deposited in the so-called collar region and/or in the transition portion 3, minerals and/or bone formation factors can be deposited on the projections 23 and/or the ribs 6.1, 6.2, 6.3, and/or platelet-rich plasma can be deposited in the ribbed region.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optional subordinated formulation characterize independent inventive refinement of the prior art, in particular to undertake divisional applications based on these claims.

1. A crestal implant, comprising an elongate anchoring portion extending in a longitudinal direction, an implant stump, and a transition portion between the anchoring portion and the implant stump, the anchoring portion having an elongate core from which a plurality of ribs extend that are distributed in the longitudinal direction and in the peripheral direction, one or more surfaces being provided at the transition portion, which surface or surfaces extend in the peripheral direction at least in certain peripheral portions at a radial reference distance from the geometrical longitudinal center axis, and the implant containing plastics and in particular consisting of plastics, characterized in that the ribs form rib groups, each of which comprises a plurality of ribs that are arranged distributed on the core periphery at a common core cross-section, that one or more rib groups are provided in which, for all ribs, the radially outer rib edge, along the entire or only partial peripheral extent thereof, has a radial distance from the geometrical longitudinal center axis of the implant that corresponds to the radial reference distance, and that one or more further rib groups are provided, within which only a number of ribs thereof, i.e., not all ribs, in particular only two ribs situated opposite from one another on the core periphery, or all ribs, have at their radially outer rib edge, along the entire or only partial peripheral extent thereof, a radial distance from the geometrical longitudinal axis that is greater than the radial reference distance.

2. The implant according to claim 1, characterized in that each of the further rib groups have a plurality of ribs, in particular in each case four ribs, of which for each rib group only a total of two ribs situated opposite from one another on the core periphery have at their radially outer rib edge, along the entire or only partial peripheral extent thereof, a radial distance from the geometrical longitudinal axis that is greater than the radial reference distance, and of which the remaining ribs have at their radially outer rib edge, along the entire or only partial peripheral extent thereof, a radial distance from the geometrical longitudinal center axis that corresponds to the reference distance.

3. The implant according to claim 1, characterized in that the transition portion has a core from which a plurality of peripheral segments extend radially outwardly and are arranged distributed in the peripheral direction, the radially outer surfaces of which extend at the radial reference distance from the geometrical longitudinal center axis in the peripheral direction and in the longitudinal direction along an imaginary cylindrical enveloping surface.

4. The implant according to claim 1, characterized in that the radially outermost rib edge of ribs extends along imaginary circular curves that are concentric with the geometrical longitudinal center axis.

5. The implant according to claim 1, characterized in that a plurality of rib groups, within which only for individual ribs or for all ribs, a radial distance between the radially outermost rib edge and the geometrical longitudinal center axis is greater than the radial reference distance, are disposed successively in the longitudinal direction.

6. The implant according to claim 1, characterized in that rib groups, within which only for individual ribs or for all ribs, a radial distance between the radially outermost rib edge and the geometrical longitudinal center axis is greater than the radial reference distance, differ from one another from rib group to rib group in terms of this radial distance.

7. The implant according to claim 1, characterized in that in a sequence of a plurality of rib groups, within which only for individual ribs or for all ribs, a radial distance between the radially outermost rib edge and the geometrical longitudinal center axis is greater than the radial reference distance, a first, maximum radial distance of the rib edges from the longitudinal axis is associated with at least one first rib group, and that in the longitudinal direction on one or both sides of the first rib group, one or more second rib groups are disposed, with which there is or are associated a second radial distance of the rib edges from the longitudinal center axis that is less than the first radial distance and greater than the radial reference distance.

8. The implant according to claim 7, characterized in that in a sequence of a plurality of rib groups, within which only for individual ribs or for all ribs, a radial distance between the radially outermost rib edge and the geometrical longitudinal center axis is greater than the radial reference distance, between at least one second rib group with which there is associated the second radial distance of the rib edges from the longitudinal center axis, and at least one rib group with which, for all ribs, there is associated the radial reference distance of the rib edges from the longitudinal center axis, at least one third rib group is disposed, with which there is associated a third radial distance from the longitudinal center axis which is less than the second radial distance from the longitudinal center axis and greater than the radial reference distance from the longitudinal center axis.

9. The implant according to claim 1, characterized in that viewed in the longitudinal direction, on either side of a sequence of a plurality of rib groups, within which only for individual ribs or for all ribs, a radial distance between the radially outermost rib edge and the geometrical longitudinal center axis is greater than the radial reference distance, one or more rib groups are disposed, of which for all ribs, in each case a radial distance between the radially outermost rib edge and the geometrical longitudinal center axis of the implant corresponds to the radial reference distance.

10. The implant according to claim 1, characterized in that ribs, the radial distance of which between the radially outermost rib edge and the geometrical longitudinal center axis corresponds to the radial reference distance, have a substantially triangular cross-section in a cross-sectional plane that extends through the geometrical longitudinal center axis.

11. The implant according to claim 1, characterized in that ribs, the radial distance of which between the radially outermost rib edge and the geometrical longitudinal center axis is greater than the radial reference distance, have a cross-section in a cross-sectional plane extending through the longitudinal center axis, which cross-section, extending from a base that adjoins the core cross-section, tapers into an elongate extension, it being provided in particular that the extension has an approximately constant cross-sectional thickness, at least in certain length portions.

12. The implant according to claim 11, characterized in that toward its free longitudinal end, the elongate extension is inclined with regard to the longitudinal center axis and oriented toward the implant stump.

13. The implant according to claim 3, characterized in that ribs are disposed in a plurality of rib rows, each rib row comprising in each case a plurality of ribs which are distributed on the core in the longitudinal direction thereof and within peripheral angle intervals on the core periphery that are identical to one another, it being provided in particular that in each case one peripheral segment of the transition portion extends within one peripheral angle interval in each case, which interval is associated with one of the rib rows.

14. The implant according to claim 8, characterized in that the implant comprises a foot end, the cross-section of which tapers toward the free longitudinal end, and which has a core from which a plurality of foot segments extend radially outwardly which are arranged distributed in the peripheral direction, it being provided in particular that in each case one foot segment extends in each case within one peripheral angle interval which corresponds to a peripheral angle interval that is associated with one of the rib rows.

15. The implant according to claim 13, characterized in that between adjacent rib rows, in particular between adjacent peripheral segments and adjacent foot segments, in each case one concavely rounded fillet extends in the longitudinal direction, in which fillet, at least in some of the rib groups, in each case one stiffening projection is embedded between adjacent ribs.

16. The implant according to claim 1, characterized in that the implant is made in one piece.

17. The implant according to claim 1, characterized in that the implant is made entirely or predominantly from plastics, in particular from or on the basis of polyamide or polyether ketone such as, e.g., polyether ether ketone (PEEK) or polyoxymethylene (e.g., Delrin) or the like.

18. The implant according to claim 1, characterized in that at the transition portion, between surfaces that extend at least in certain peripheral portions in the peripheral direction at the radial distance from the geometrical longitudinal center axis, one or more, in particular two, projections are formed that are situated diametrically opposite from one another on the periphery and extend radially outwardly, the radial distance between the outer surface of the projections and the longitudinal center axis being greater than the radial reference distance, and it being provided in particular that in a cross-sectional plane perpendicular to the geometrical center axis, the projections have a wedge-shaped, radially outwardly tapered cross-section, and in a cross-sectional plane extending through the geometrical center axis, they have a rectangular cross-section.

19. The implant according to claim 1, characterized in that the implant stump has a rotationally symmetrical design.

20. The implant according to claim 1, characterized in that a first surface region of a dental implant region, the implant material of which consists of polyether ether ketone or at least contains polyether ether ketone, and at least one second surface region of a dental implant region, the implant material of which consists of polyether ether ketone or at least contains polyether ether ketone, are in each case prepared by means of mechanical and/or physical and/or chemical action so that the surface retentivity of the surface resulting from the preparation of the first surface region differs, at least in certain regions, from the surface retentivity of the surface resulting from the preparation of the second surface region, and the surface retentivity of the surfaces resulting from the preparation differs, at least in certain regions, from the surface retentivity of the surface region associated in each case with the surfaces prior to the preparation.

21. The implant according to claim 20, characterized in that the first surface region and the second surface region are spaced apart from one another on the dental implant.

22. The implant according to claim 20, characterized in that on one or on both of the at least two surface regions of the dental implant, there is a deposit of at least one organic substance and/or of at least one inorganic substance, which latter is in particular a mineral substance.

23. The implant according to claim 22, characterized in that the substance is deposited into a cavity or into a cutout, in particular into a through-hole and/or into one or more indentations or pores that are open toward the outside of the implant.

24. The implant according to claim 1, characterized in that one or both of these at least two surface regions of the dental implant is or are prepared by means of ionizing plasma treatment, in particular by means of ionizing cold plasma treatment, at atmospheric pressure.

25. A method for working on a crestal implant, characterized in that an implant according to claim 1 is provided, and that the implant is shortened in the longitudinal direction at individual or a plurality of places, and/or that ribs of the implant for which in each case a radial distance between the outermost rib edge and the geometrical longitudinal center axis is greater than the radial reference distance, are ablated and/or shortened from their free longitudinal ends or edges, and/or that the implant provided is an implant in which projections of the implant are shortened and/or weakened or removed.

26. The method according to claim 25, characterized in that the shortening in the longitudinal direction takes place by means of cutting off implant parts, in particular in the basal and/or crestal region, it being provided in particular that the foot end is cut off and/or that for cutting off one or more rib groups, the core is cut through, and/or that one or both conical length portions are cut off and/or ground.

27. The method according to claim 25, characterized in that the projections are shortened and/or weakened or removed, in particular by ablating or cutting off the projections by means of a cutting instrument.

28. The method for working on an implant, characterized in that an implant according to claim 1 is provided, that a first surface region of a dental implant region, the implant material of which consists of polyether ether ketone or at least contains polyether ether ketone, and at least one second surface region of a dental implant region, the implant material of which consists of polyether ether ketone or at least contains polyether ether ketone, are in each case prepared by means of mechanical and/or physical and/or chemical action so that the surface retentivity of the surface resulting from the preparation of the first surface region differs, at least in certain regions, from the surface retentivity of the surface resulting from the preparation of the second surface region, and the surface retentivity of the surfaces resulting from the preparation differs, at least in certain regions, from the surface retentivity of the surface region associated in each case with the surfaces prior to the preparation.

29. The method according to claim 28, characterized in that on one or both of these at least two surface regions of the dental implant, at least one organic substance is deposited, and/or that on one or both of these at least two surface regions of the dental implant, at least one inorganic substance is deposited, in particular a mineral substance being used as the inorganic substance.

30. The method according to claim 29, characterized in that the substance is deposited in at least one cavity or in at least one cutout, in particular in at least one through-hole and/or in one or more indentations or pores that are open toward the outside of the implant.

31. The method according to claim 28, characterized in that one or both of the at least two surface regions of the implant is or are treated by means of plasma treatment, in particular by means of ionizing cold plasma treatment, at atmospheric pressure.
